(19) United States
(12) Patent Application Publication
(10) Pub. No.: US 2026/0176434 A1
(43) Pub. Date: Jun. 25, 2026

(54) Quality Check Solution For Swellable Polymer Gels

(71) Applicants: Chevron U.S.A. Inc., San Ramon, CA (US); Triad National Security, LLC, Los Alamos, NM (US)

(72) Inventors: Ishtiaque Anwar, Los Alamos, NM (US); Meng Meng, Los Alamos, NM (US); Robert David Gilbertson, Los Alamos, NM (US); James William Carey, Houston, TX (US); Rajesh S. Nair, Houston, TX (US); Weicheng Zhang, Houston, TX (US)

(21) Appl. No.: 18/988,534

(22) Filed: Dec. 19, 2024

(51) Int. Cl. C08J 7/02; G01N 19/00

(52) U.S. Cl. CPC C08J 7/02; G01N 19/00; C08J 2300/14

(57) ABSTRACT

A quality check test can be performed on a swellable polymer gel before the swellable polymer gel is deployed in a well or other structure to seal a void. The quality check test comprises placing an initial volume of the swellable polymer gel in a container containing the quality check solution. In response to the swellable polymer gel reacting with the quality check solution, an amount of volume expansion of the initial volume of the swellable polymer gel is determined. The swellable polymer gel satisfies the quality check test when the amount of volume expansion satisfies a predetermined volume expansion amount. The quality check solution comprises carbonated water and an inorganic acid.

### STATEMENT REGARDING FEDERAL RIGHTS

The United States government has certain rights in this invention pursuant to Contract No. 89233218CNA000001 between the United States Department of Energy and TRIAD National Security, LLC for the operation of Los Alamos National Laboratory.

### PARTIES TO JOINT RESEARCH AGREEMENT

The research work described here was performed under a Cooperative Research and Development Agreement (CRADA) between Los Alamos National Laboratory (LANL) and Chevron under the LANL-Chevron Alliance, CRADA number LA05C10518.

### TECHNICAL FIELD

The present disclosure relates generally to quality check solutions used to test the quality of swellable polymer gels that are used for sealing cracks and voids in wells and other structures.

### BACKGROUND

Wells are drilled into land and subsea formations to produce resources such as water and hydrocarbons (e.g. petroleum and natural gas). Recently, wells also are being used to sequester carbon dioxide. The safe, environmentally friendly, and cost-efficient development of oil and gas resources as well as carbon sequestration are becoming increasingly complex. For example, deeper and more complex onshore and offshore wells must produce reliably over longer periods of time to justify the large capital expenditures necessary to develop them. Given the additional time a well is required to produce or provide an adequate seal in the subsurface, additional complexities are added to maintaining the safe and cost-effective maintenance of wells.

New compositions, methods, and systems are needed to enhance, maintain, or repair subsurface integrity within a well or near a wellbore region. For example, oil and gas producing wells and wells used for carbon sequestration typically experience high pressure and temperature conditions, which could lead to induced stresses on cemented annuli leading to potential containment loss, for instance, CO₂ and/or H₂S leakage through microannuli (e.g., delaminations along the interface of steel and solid cement) or micro-fractures in the well system. Swellable polymer gels have been developed that can be used to seal flaws, voids, cracks, fissures, and micro-fractures in and around wells. However, techniques for ensuring the quality and reliability of swellable polymer gels would be beneficial.

### SUMMARY

The example embodiments provided herein relate to a quality check solution for testing swellable polymer gels. In one example embodiment, a method of performing a quality check test on a swellable polymer gel may comprise: (i) placing an initial volume of the swellable polymer gel in a container containing a quality check solution for a period of time resulting in an expanded polymer gel; (ii) in response to the swellable polymer gel reacting with the quality check solution, determining an amount of volume expansion of the expanded polymer gel relative to the initial volume of the swellable polymer gel; (iii) comparing the amount of volume expansion of the initial volume of the swellable polymer gel to a predetermined volume expansion amount; and (iv) determining that the swellable polymer gel satisfies the quality check test when the swellable polymer gel expands from the initial volume to the predetermined volume expansion amount, wherein the quality check solution comprises: carbonated water comprising 1.2 to 6.5 volumes of carbon dioxide; and 0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid.

In another example embodiment, a quality check solution may comprise: (i) carbonated water comprising 1.2 to 6.5 volumes of carbon dioxide; and (ii) 0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid.

In yet another example embodiment, a method of making a quality check solution comprises combining: (i) carbonated water comprising 1.2 to 6.5 volumes of carbon dioxide; (ii) 0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid; (iii) 0.04 to 0.08 wt % of an organic acid selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid; and (iv) 0.01 to 0.18 wt % of an anti-caking agent selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments relating to ensuring the quality of swellable polymer gels and therefore are not to be considered limiting of the scope of this disclosure. The principles illustrated in the example embodiments of the drawings can be applied to alternate methods and compositions. Additionally, the elements and features shown in the drawings are not necessarily to scale, emphasis instead being placed upon clearly illustrating the principles of the example embodiments. In the drawings, the same reference numerals used in different embodiments designate like or corresponding, but not necessarily identical, elements.

FIG. 1 illustrates a method of making a quality check solution in accordance with an example embodiment of the disclosure.

FIG. 2 illustrates a method of using a quality check solution to perform a quality check test on a swellable polymer gel in accordance with an example embodiment of the disclosure.

FIG. 3 illustrates a sample of a swellable polymer gel in a solid state before being exposed to a quality check test using a quality check solution in accordance with an example embodiment of the disclosure.

FIG. 4A illustrates the swellable polymer gel of FIG. 3 just after being placed in a vial of quality check solution in accordance with an example embodiment of the disclosure.

FIG. 4B illustrates the swellable polymer gel after it has expanded after being placed in a vial to measure the volume of expansion in accordance with an example embodiment of the disclosure.

FIG. 5 illustrates a well pad comprising two hydrocarbon wells in which a swellable polymer gel can be placed in accordance with an example embodiment of the disclosure.

### DETAILED DESCRIPTION OF EXAMPLE EMBODIMENTS

As identified above, swellable polymer gels offer a promising solution for sealing a variety of cracks and voids in wells. Swellable polymer gels have become a preferred method for ensuring wells are properly sealed due to their affordability and unique ability to be triggered in the presence of carbon dioxide and pH changes. Swellable polymer gels also have other potential applications for sealing cracks and voids in a variety of cement and rock structures. However, there are substantial opportunities for mishaps during the synthesis, storage, and transport of swellable polymer gels that can lead to defects in the quality of the gel and its ability to expand and properly seal a well. Given the costs and complexities involved in placing a swellable polymer gel in a well, placing a defective swellable polymer gel in a well can lead to substantial challenges and repair costs. Accordingly, there is a need to ensure the quality and reliability of swellable polymer gels before they are introduced into wells or other structures to ensure they will perform the desired sealing function.

Existing approaches to testing the quality of swellable polymer gels are costly, time-consuming, and involve complex equipment. Currently, to ensure the quality of swellable polymer gels, complex analytical measurements are conducted, such as chemical analysis, rheological measurements, and spectroscopic analysis. However, such complex analytical measurements are expensive and require sophisticated equipment in a lab. The complexity of existing testing techniques makes it impractical to test swellable polymer gels in the field, such as near a wellsite. Additionally, these complex testing techniques are often inconclusive with respect to assessing the quality of the swellable polymer gel.

The example embodiments discussed herein are directed to compositions and methods that provide a simpler approach to testing the quality of swellable polymer gels. The example embodiments described herein provide a quality check solution that can rapidly test the quality of a swellable polymer gel before the gel is placed in a well. The quality check solution described herein also offers advantages of simplicity and portability allowing it to be used in the field near a wellsite. The ability to verify the quality of a swellable polymer gel before it is placed in a well or another structure provides a significant advantage.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

As used herein, the term “swellable polymer gel” refers to a class of polymer gels that swell upon sensing a specific trigger. The smart gel may also collapse when the trigger is removed. Triggers include, but are not limited to, pH, temperature, concentration of metal ions, and/or acoustic, electric, and/or magnetic stimuli. The swellable element within the swellable polymer gel typically expands to several times the original size of the swellable polymer gel (the size prior to trigger) when the trigger is applied.

As background, swellable polymer gels may be engineered to a particular size range so that they can be pumped as a suspension in an appropriate working fluid into a well and into voids, such as cracks or microannuli in a cemented wellbore. Voids can occur throughout the well system, for example within the wellhead, the cement, in and around tubing, and in and around casing. The swellable polymer gel is placed into the voids in a collapsed state, where it remains until it is triggered to cause expansion, filling the voids. In embodiments, the expansion of the swellable polymer gel creates a reversible localized seal that reduces or eliminates liquid and gas flow within the targeted void. If desired, the flow within the void can be restored by collapsing the smart gel by reversing the trigger. The use of swellable polymer gels is described in greater detail in U.S. Pat. No. 11,879,090.

### Examples of Quality Check Solution and Methods of Making Same

Example embodiments of the quality check solution used for testing a swellable polymer gel will now be described. In general, the quality check solution is a composition comprising carbonated water and an inorganic acid. The quality check solution may comprise 1.2 to 6.5 volumes of carbon dioxide and 0.04 to 0.15 wt % of the inorganic acid. The volumes of carbon dioxide are measured such that if a one-liter of a quality check solution has 2.0 volumes of carbon dioxide, this means that the dissolved carbon dioxide in the one-liter of quality check solution would fill 2.0 liters if released as carbon dioxide gas at atmospheric pressure.

The inorganic acid in the above example quality check solution may be selected from: phosphoric acid, sulfuric acid, hydrochloric acid, nitric acid, carbonic acid, boric acid, chromic acid, perchloric acid, and hydrofluoric acid. The inorganic acid in combination with the dissolved carbon dioxide reduces the pH of the quality check solution to a level for triggering the swellable polymer gel. As an example, the pH of the quality check solution may be in the range of 5 to 6.5. This example quality check solution is designed to test the quality of swellable polymer gels that are triggered by an acidic pH. In other examples in which a swellable polymer gel is triggered by other conditions such as temperature, the quality check solution can be modified to provide the necessary condition to trigger the swellable polymer gel. In other words, the quality check solution can simulate the conditions to which swellable polymer gel would be exposed when placed in or near the void that the gel is intended to seal.

In addition to the presence of dissolved carbon dioxide and an inorganic acid, the foregoing examples of the quality check solution may also include an organic acid. The addition of an organic acid can accelerate the reaction with the swellable polymer gel thereby providing a result of the quality check test sooner. As an example, when an organic acid is included in the quality check solution, the quality check test can be completed within 60 minutes or within 45 minutes of exposing the swellable polymer gel to the quality check solution. The ability to complete the quality check test on a sample of swellable polymer gel within 60 minutes or within 45 minutes facilitates use of the quality check test in the field before the swellable polymer gel is deployed in a well or other structure. Additional benefits of including an organic acid in the quality check solution include improved pH regulation, extended shelf life of the quality check solution, and carbonation stabilization. The organic acid may be selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid.

In addition to the presence of dissolved carbon dioxide and an inorganic acid, the foregoing examples of the quality check solution may also include an anti-caking agent. The anti-caking agent can inhibit the formation of clumps of material in the quality check solution. The anti-caking agent also can assist with buffering the acidity of the quality check solution and stabilizing the dissolved carbon dioxide. The anti-caking agent may be selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate.

Various combinations of the foregoing components may be included in the quality check solution to achieve a desired effect. As one example, the quality check solution may comprise: (i) carbonated water having 1.2 to 6.5 volumes of dissolved carbon dioxide, and (ii) 0.04 to 0.15 wt % of an inorganic acid, wherein the inorganic acid is any of the previously described inorganic acids. In another example embodiment, the quality check solution may comprise: (i) carbonated water having 1.2 to 6.5 volumes of dissolved carbon dioxide, (ii) 0.04 to 0.15 wt % of an inorganic acid, and (iii) 0.04 to 0.08 wt % of an organic acid, wherein the organic acid is any of the previously described organic acids. In yet another example embodiment, the quality check solution may comprise: (i) carbonated water having 1.2 to 6.5 volumes of dissolved carbon dioxide, (ii) 0.04 to 0.15 wt % of an inorganic acid, and (iii) 0.01 to 0.18 wt % of an anti-caking agent, wherein the anti-caking agent is any of the previously described anti-caking agents. In yet another example embodiment, the quality check solution may comprise: (i) carbonated water having 1.2 to 6.5 volumes of dissolved carbon dioxide, (ii) 0.04 to 0.15 wt % of an inorganic acid, (iii) 0.04 to 0.08 wt % of an organic acid, wherein the organic acid is any of the previously described organic acids, and (iv) 0.01 to 0.18 wt % of an anti-caking agent, wherein the anti-caking agent is any of the previously described anti-caking agents. Lastly, in yet another example embodiment, the quality check solution may comprise: (i) carbonated water having 1.2 to 6.5 volumes of dissolved carbon dioxide, (ii) 0.04 to 0.15 wt % of phosphoric acid, (iii) 0.04 to 0.08 wt % of citric acid, and (iv) 0.01 to 0.18 wt % of potassium citrate.

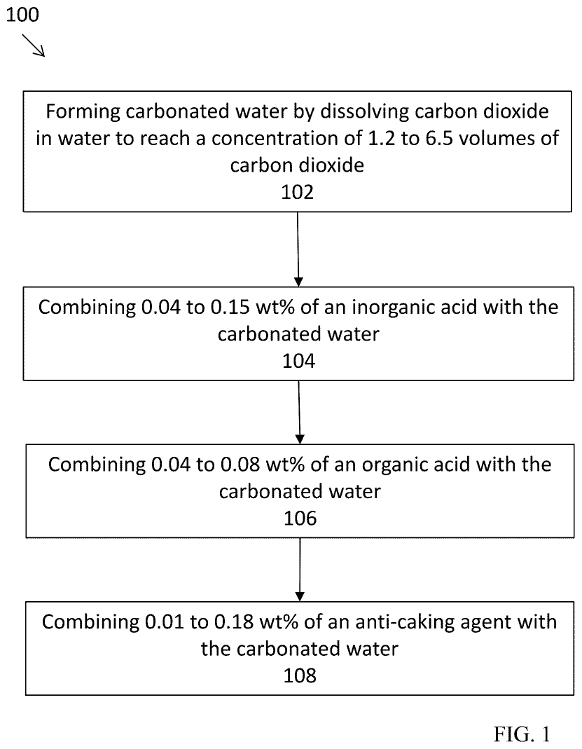

Turning now to FIG. 1, an example method 100 is illustrated for making a quality check solution in accordance with the example embodiments of this disclosure. In step 102, carbonated water is formed by dissolving carbon dioxide in water until the dissolved carbon dioxide reaches a concentration of 1.2 to 6.5 volumes of carbon dioxide. As explained previously, the volumes of carbon dioxide are measured such that if a one-liter of a quality check solution has 2.0 volumes of carbon dioxide, this means that the dissolved carbon dioxide in the one-liter of quality check solution would fill 2.0 liters if released as carbon dioxide gas at atmospheric pressure.

A variety of techniques can be used to incorporate carbon dioxide into the water. Carbon dioxide tablets may be added directly to the water to produce carbonation, as an example. Another method is using baking soda or sodium bicarbonate in conjunction with vinegar to produce carbon dioxide via a chemical reaction. Equipment such as soda makers or soda siphons also may be used to introduce carbon dioxide into the water, ensuring a precise and constant procedure for carbonation. In addition, other materials including potassium bicarbonate, calcium carbonate, or magnesium carbonate may be used to infuse carbon dioxide in the water. On a larger scale, carbon dioxide stored under pressure in one or more tanks may be injected into the water using a carbonation tank or an in-line diffuser.

In step 104 of method 100, an inorganic acid may be combined with the carbonated water formed in step 102. As described previously, the inorganic acid may be selected from: phosphoric acid, sulfuric acid, hydrochloric acid, nitric acid, carbonic acid, boric acid, chromic acid, perchloric acid, and hydrofluoric acid. The inorganic acid in combination with the dissolved carbon dioxide reduces the pH of the quality check solution to a level for triggering the swellable polymer gel.

In step 106 of method 100, an organic acid may be combined with the carbonated water formed in step 102. As described previously, the organic acid may be selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid. The presence of the organic acid in the quality check solution can accelerate the reaction with the sample of swellable polymer gel so that the quality check test is completed more rapidly.

In step 108 of method 100, an anti-caking agent may be combined with the carbonated water formed in step 102. As described previously, the anti-caking agent may be selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate. The presence of the anti-caking agent in the quality check solution can inhibit the formation of clumps of material in the quality check solution as well as assisting with buffering the acidity of the quality check solution and stabilizing the dissolved carbon dioxide.

Once the quality check solution is formed, it may be used to test samples of swellable polymer gel as described further below. It should be understood that the example method 100 of FIG. 1 can be modified within the scope of this disclosure. For example, certain steps of method 100 may be altered, performed in parallel, or performed in a different sequence. Moreover, additional steps may be added in sequence or in parallel to the method 100.

### Examples of Using the Quality Check Solution

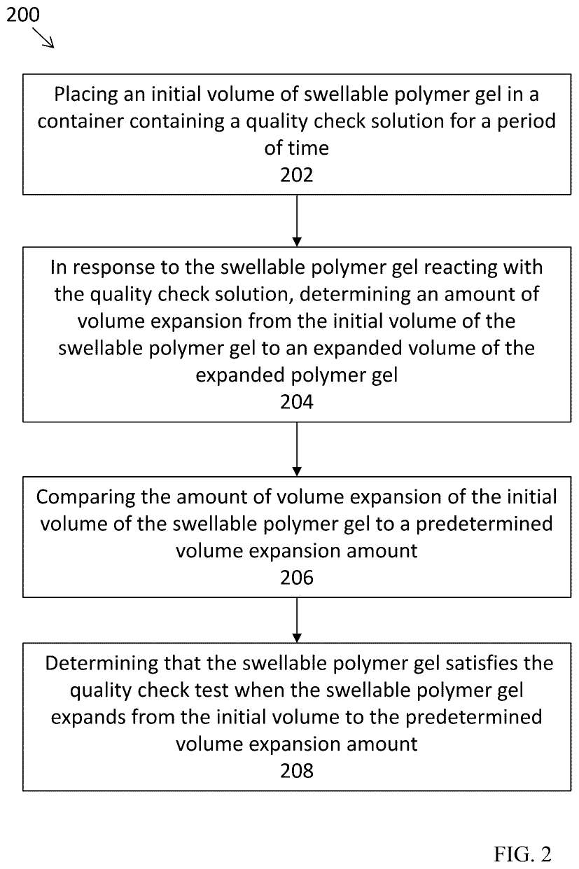

Referring now to FIG. 2, an example method 200 is illustrated for using a quality check solution to test a sample of a swellable polymer gel. As described previously, it is advantageous to test the quality of a swellable polymer gel before it is placed in a well or other structure. The portability of the quality check solution described herein allows for testing of samples of swellable polymer gel at a variety of locations, including at or near a well site. Any of the examples of quality check solutions previously described may be used in the example method of FIG. 2.

In step 202 of method 200, an initial volume of a sample of a swellable polymer gel may be placed in a container containing a quality check solution. As an illustrative example, the container may be a vial containing 25 to 75 ml of the quality check solution. The sample of the swellable polymer gel may be left in the container for a period of time, such as 45 to 60 minutes, while it reacts with the quality check solution resulting in an expanded polymer gel.

In step 204, in response to the swellable polymer gel reacting with the quality check solution, the volume of the swellable polymer gel may be measured to determine an amount of volume expansion from the initial volume to the expanded volume of the expanded polymer gel. One method of measuring the amount of volume expansion may be measuring a displacement of fluid in which the expanded polymer gel is placed.

In step 206, the amount of volume expansion of the initial volume of the swellable polymer gel may be compared to a predetermined volume expansion amount. For example, it may be expected that the swellable polymer gel should expand to at least two times, or at least ten times, or at least twenty times its initial volume in response to reacting with the quality check solution. The predetermined volume expansion amount may be the expected amount of expansion or a certain fraction of the expected amount of expansion.

In step 208, if it is determined that the measured amount of volume expansion meets the predetermined volume expansion amount, then it is determined that the swellable polymer gel satisfies the quality check test. Alternatively, if the measured amount of volume expansion of the sample of swellable polymer gel that was placed in the quality check solution does not meet the predetermined volume expansion amount, then it is determined that the swellable polymer gel does not satisfy the quality check test and should not be placed in the well or other structure for sealing voids or cracks.

It should be understood that the example method 200 of FIG. 2A can be modified within the scope of this disclosure. For example, certain steps of method 200 may be altered. Moreover, additional steps may be added in sequence or in parallel to the method 200.

### Experimental Results

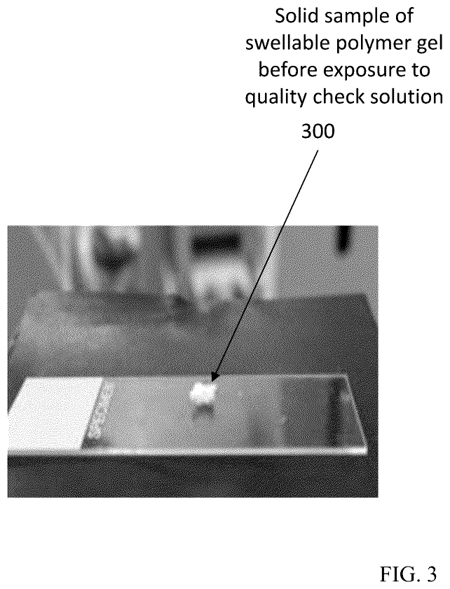

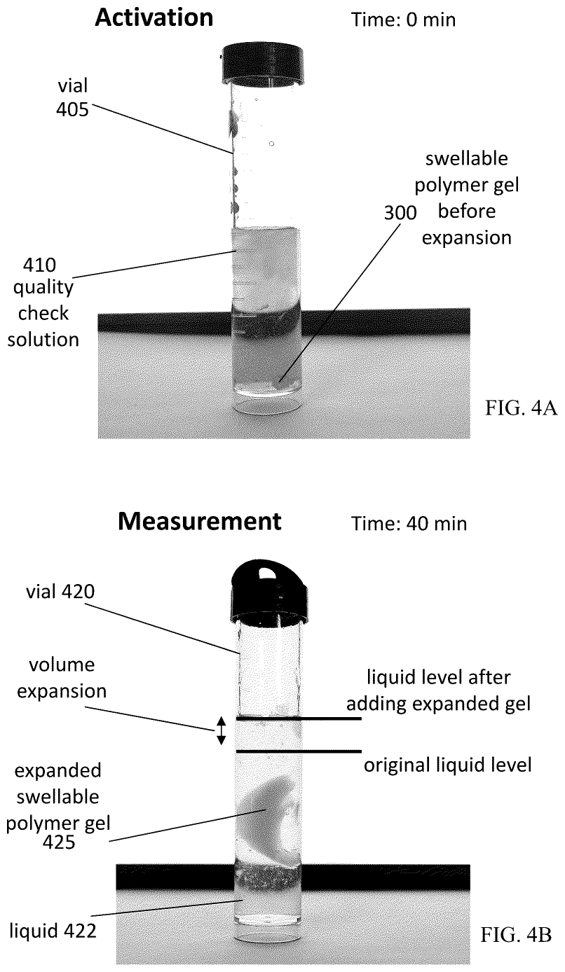

Referring now to FIGS. 3, 4A, and 4B, experimental data relating to an example embodiment of the quality check solution will be described. For the experimental investigation, an example quality check solution was used having the following composition: (i) carbonated water with a concentration of 2.5 volumes of carbon dioxide, (ii) 0.05 wt % of phosphoric acid, (iii) 0.01 wt % of potassium citrate, and (iv) 0.01% of citric acid. The quality check solution 410 was placed in a vial 405 as illustrated in FIG. 4A.

A solid sample of swellable polymer gel 300, as illustrated in FIG. 3, was obtained from a supply of swellable polymer gel. The initial volume of the sample of the swellable polymer gel 300 was measured before placing the sample in the quality check solution. The initial volume of the sample of the swellable polymer gel 300 can be measured with an automated profiler or by measuring fluid displacement in a graduated cylinder. In the illustrated example of FIGS. 3-4B, it was determined that the initial volume of the swellable polymer gel was negligible.

The sample of the swellable polymer gel 300 was then submerged in the quality check solution 410 in the vial 405 for a period of 45 minutes. The image of FIG. 4A shows the swellable polymer gel 300 at time 0 minutes just after being placed in the quality check solution 410 and before it has begun to swell. The reaction of the sample of the swellable polymer gel 300 with the quality check solution 410 caused the sample to expand to an expanded swellable polymer gel 425 having an expanded volume.

FIG. 4B illustrates the measurement of the expanded volume using a separate vial 420 having a liquid 422. Liquid 422 may be quality check solution, water, or another liquid. FIG. 4B indicates an original level of the liquid 422 in the vial 420 before addition of the expanded swellable polymer gel 425 to the vial 420 and a liquid level after adding the expanded swellable polymer gel 425 to the vial 420. The amount of volume expansion from the initial volume of the swellable polymer gel to the expanded volume of the expanded polymer gel can be measured by measuring fluid displacement in the vial 405 as illustrated in FIG. 4B.

The foregoing process was repeated for three samples of swellable polymer gel. The results of the experiment are provided in Table 1 below.

TABLE 1

| | Initial weight, | Initial | Swelled |
|---|---|---|---|
| Sample ID | g (air dried) | volume (ml) | volume (ml) |
| 01 | 0.012 | 0.122 | 2.044 |
| 02 | 0.014 | 0.140 | 2.108 |
| 03 | 0.012 | 0.124 | 2.206 |

The difference between the initial volume and the swelled volume is the amount of expansion for each sample. If the amount of expansion meets a predetermined volume of expansion amount that is expected for the swellable polymer gel, then the sample satisfies the quality check test.

### Applications

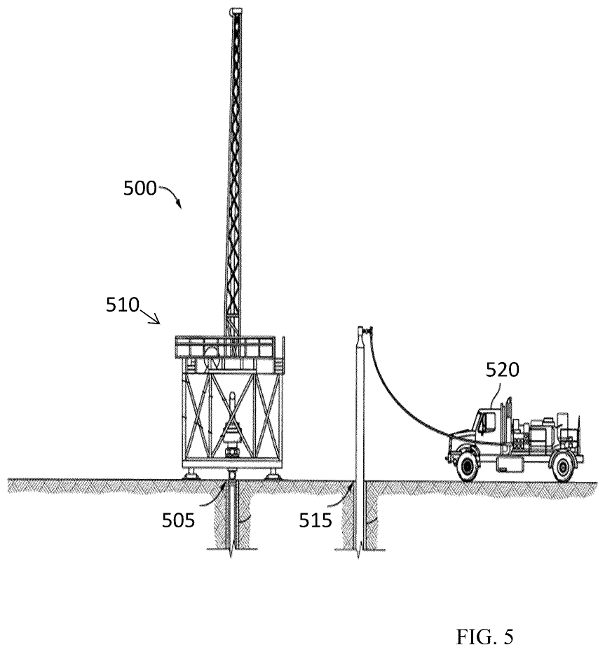

Referring now to FIG. 5, an example of a hydrocarbon well pad 500 is illustrated. In FIG. 5, the well pad 500 includes a first well 505 and a second well 515. A rig 510 is disposed over the first well 505. A pumping truck 520 is disposed adjacent to the second well 515 and the pumping truck 520 is injecting a working fluid comprising a swellable polymer gel into the second well 515. As described in accordance with the foregoing embodiments, a sample of the swellable polymer gel can be tested using a quality check solution to ensure the swellable polymer gel is of sufficient quality before injecting it into the wells 505 and 515.

As referenced previously, swellable polymer gels have other applications for sealing voids and cracks in rock and cement structures. Accordingly, the quality check solution can likewise be used to verify the quality of swellable polymer gels before they are placed in rock and cement structures.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

Terms such as “first”, “second”, “top”, “bottom”, “side”, “distal”, “proximal”, and “within” are used merely to distinguish one step or component from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method of performing a quality check test on a swellable polymer gel, the method comprising:
placing an initial volume of the swellable polymer gel in a container containing a quality check solution for a period of time resulting in an expanded polymer gel;
in response to the swellable polymer gel reacting with the quality check solution, determining an amount of volume expansion of the expanded polymer gel relative to the initial volume of the swellable polymer gel;
comparing the amount of volume expansion of the initial volume of the swellable polymer gel to a predetermined volume expansion amount; and
determining that the swellable polymer gel satisfies the quality check test when the swellable polymer gel expands from the initial volume to the predetermined volume expansion amount,
wherein the quality check solution comprises:
carbonated water comprising 1.2 to 6.5 volumes of carbon dioxide; and
0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid.

2. The method of claim 1, wherein the quality check solution further comprises 0.04 to 0.08 wt % of an organic acid selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid.

3. The method of claim 1, wherein the quality check solution further comprises 0.01 to 0.18 wt % of an anti-caking agent selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate.

4. The method of claim 1, wherein the inorganic acid is phosphoric acid and wherein the quality check solution further comprises 0.01 to 0.18 wt % of potassium citrate and 0.04 to 0.08 wt % of citric acid.

5. The method of claim 1, wherein the quality check solution further comprises 0.01 to 0.18 wt % of potassium citrate.

6. The method of claim 1, wherein the quality check solution further comprises 0.04 to 0.08 wt % of citric acid.

7. The method of claim 1, wherein the swellable polymer gel is in a liquid state as it is placed into the container containing the quality check solution.

8. The method of claim 1, wherein the swellable polymer gel is in a solid state as it is placed into the container containing the quality check solution.

9. The method of claim 1, wherein the predetermined volume expansion amount is 8 to 10 times the initial volume.

10. The method of claim 1, wherein the predetermined volume expansion amount is 11 to 30 times the initial volume.

11. The method of claim 1, wherein a volume of the quality check solution in the container is 25 to 75 ml.

12. The method of claim 1, wherein the swellable polymer gel expands to the predetermined volume expansion amount within 60 minutes of placing the initial volume of the swellable polymer gel in the container containing the quality check solution.

13. A quality check solution comprising:
carbonated water comprising 1.2 to 6.5 volumes of carbon dioxide; and
0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid.

14. The quality check solution of claim 13, wherein the quality check solution further comprises 0.04 to 0.08 wt % of an organic acid selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid.

15. The quality check solution of claim 13, wherein the quality check solution further comprises 0.01 to 0.18 wt % of an anti-caking agent selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate.

16. The quality check solution of claim 13, wherein the inorganic acid is phosphoric acid and wherein the quality check solution further comprises 0.01 to 0.18 wt % of potassium citrate and 0.04 to 0.08 wt % of citric acid.

17. The quality check solution of claim 13, further comprising 0.01 to 0.18 wt % of potassium citrate.

18. The quality check solution of claim 13, further comprising 0.04 to 0.08 wt % of citric acid.

19. A method of making a quality check solution comprising combining:
carbonated water comprising 1.2 to 6.5 volumes of carbon dioxide;
0.04 to 0.15 wt % of an inorganic acid selected from: phosphoric acid, sulfuric acid, hydrochloric acid, nitric acid, carbonic acid, boric acid, chromic acid, perchloric acid, and hydrofluoric acid;
0.04 to 0.08 wt % of an organic acid selected from: citric acid, acetic acid, tartaric acid, malic acid, fumaric acid, lactic acid, ascorbic acid, formic acid, oxalic acid, succinic acid, benzoic acid, butyric acid, propionic acid, glutaric acid, and phthalic acid; and
0.01 to 0.18 wt % of an anti-caking agent selected from: potassium citrate, sodium citrate, calcium citrate, magnesium citrate, ammonium citrate, citric acid, silicon dioxide, calcium silicate, tricalcium phosphate, magnesium stearate, sodium aluminosilicate, and calcium carbonate.

20. The method of claim 19, wherein the inorganic acid is phosphoric acid, wherein the organic acid is citric acid, and wherein the anti-caking agent is potassium citrate.
